(19) United States
(12) Patent Application Publication
(10) Pub. No.: US 2017/0043453 A1
(43) Pub. Date: Feb. 16, 2017

(54) CONNECTOR FOR WOODWORKING CLAMPERS

(71) Applicant: WEN-CHE CHEN, Taichung City (TW)

(72) Inventor: WEN-CHE CHEN, Taichung City (TW)

(21) Appl. No.: 14/822,127

(22) Filed: Aug. 10, 2015

(51) Int. Cl. B25B 5/00; B25B 5/16

(52) U.S. Cl. CPC B25B 5/003; B25B 5/163

(57) ABSTRACT

A connector contains a body including: a first inserting orifice, a second inserting orifice, a first fixer, and a second fixer. The first inserting orifice is defined on a first end of the body, and the second inserting orifice is formed on a second end of the body opposite to the first end of the body, such that a connection rod for connecting two main woodworking clampers is inserted into the first inserting orifice and the second inserting orifice. The first fixer is inserted into the first inserting orifice from one side surface of the body to fix the connection rod, and the second fixer is inserted into the second inserting orifice from the one side surface of the body to position the connection rod more securely.

### FIELD OF THE INVENTION

The present invention relates to a connector which is employed to connect a plurality of woodworking clampers together at different angles and in various directions to change a clamping position of workpiece(s), i.e., wooden board(s).

### BACKGROUND OF THE INVENTION

A conventional clamper is disclosed in U.S. Pat. No. 7,322,571 B2 to clamp a wooden board, wherein the clamper contains a fixed head arranged on a front end thereof and a dovetail groove. However, it cannot clamp the wooden board within a wide range.

The present invention has arisen to mitigate and/or obviate the afore-described disadvantages.

### SUMMARY OF THE INVENTION

The primary objective of the present invention is to provide a connector which is employed to connect a plurality of woodworking clampers together at different angles and in various directions to change a clamping position of workpiece(s), i.e., wooden board(s).

To obtain the above objective, a connector provided by the present invention contains: a body including: a first inserting orifice, a second inserting orifice, a first fixer, and a second fixer.

The first inserting orifice is defined on a first end of the body, and the second inserting orifice is formed on a second end of the body opposite to the first end of the body, such that a connection rod for connecting two main woodworking clampers is inserted into the first inserting orifice and the second inserting orifice.

The first fixer is inserted into the first inserting orifice from one side surface of the body to fix the connection rod, and the second fixer is inserted into the second inserting orifice from the one side surface of the body to position the connection rod more securely.

Preferably, the body further includes a first holder and a second holder, wherein the first holder has the first inserting orifice and the first fixer, and the second holder has the second inserting orifice and the second fixer; The first holder also has a first dovetail protrusion arranged thereon opposite to the first inserting orifice and has a second dovetail protrusion extending outwardly from a first end surface thereof; the second holder also has a first dovetail groove arranged thereon opposite to the second inserting orifice to selectively retain with the first dovetail protrusion or the second dovetail protrusion.

Preferably, the first dovetail protrusion has a third inserting orifice defined thereon to corresponding to the second inserting orifice.

Preferably, the first holder further has an accommodating slot defined in a second end surface thereof opposite to the second dovetail protrusion and has a fixing post inserted through the accommodating slot, and the accommodating slot has a spring accommodated therein and fitted onto the fixing post; the accommodating slot also has two locating pieces fixed therein, wherein the fixing post inserts through the two locating pieces, and the spring is defined between and abuts against the two locating pieces, wherein the two locating pieces partially extend out of the accommodating slot; the fixing post has two apertures formed on each of two ends thereof to connect with an auxiliary woodworking clamper.

Preferably, the first holder further has a locking boss arranged on the first end surface thereof adjacent to the second dovetail protrusion to contact with the second holder.

Preferably, the first holder further has two crisscross holes defined on each of two side surfaces thereof, and each of the locating pieces has a crisscross hole formed thereon, such that the fixing post is vertically or horizontally inserted through the first holder.

Preferably, each of the two locating pieces has a first bolt inserted into the accommodating slot via an upper end thereof and has a second bolt inserted into the accommodating slot via a lower end thereof to locate below the spring.

### BRIEF DESCRIPTION OF THE DRAWINGS

FIG. 1 is a perspective view showing the exploded components of a connector for woodworking clampers according to a first embodiment of the present invention.

FIG. 2 is a perspective view showing the assembly of the connector for woodworking clampers according to the first embodiment of the present invention.

FIG. 3 is another perspective view showing the assembly of the connector for woodworking clampers according to the first embodiment of the present invention.

FIG. 4 is a perspective view showing the operation of the connector for woodworking clampers according to the first embodiment of the present invention.

FIG. 5 is another perspective view showing the operation of the connector for woodworking clampers according to the first embodiment of the present invention.

FIGS. 6 to 8 are a cross sectional view showing the operation of the connector for woodworking dampers according to the first embodiment of the present invention.

FIG. 9 is a perspective view showing the application of the connector for woodworking clampers according to the first embodiment of the present invention.

FIG. 10 is a plane view showing the application of the connector for woodworking clampers according to a second embodiment of the present invention.

FIG. 11 is a perspective view showing the application of the connector for woodworking clampers according to a third embodiment of the present invention.

FIG. 12 is a perspective view showing the application of the connector for woodworking clampers according to a fourth embodiment of the present invention.

FIG. 13 is a perspective view showing the application of the connector for woodworking clampers according to a fifth embodiment of the present invention.

### DETAILED DESCRIPTION OF THE PREFERRED EMBODIMENTS

A connector according to a first embodiment of the present invention is employed to connect a plurality of woodworking clampers together at different angles and in various directions to change a clamping position of workpiece(s), i.e., wooden board(s).

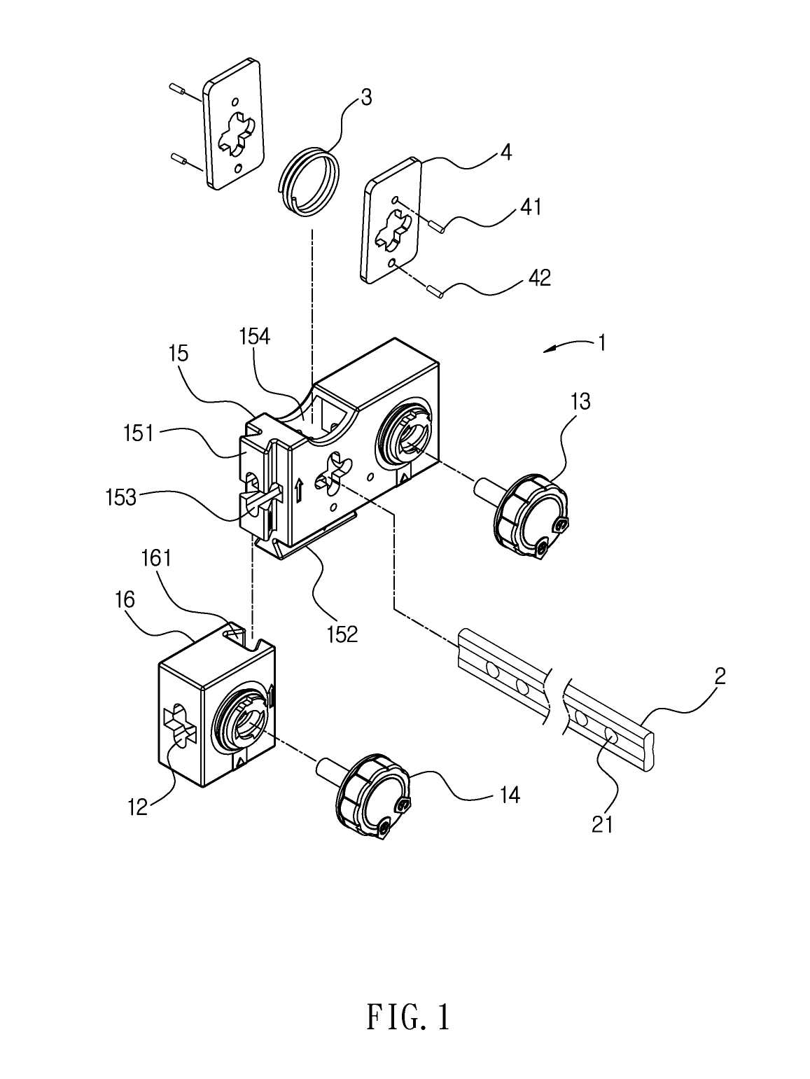

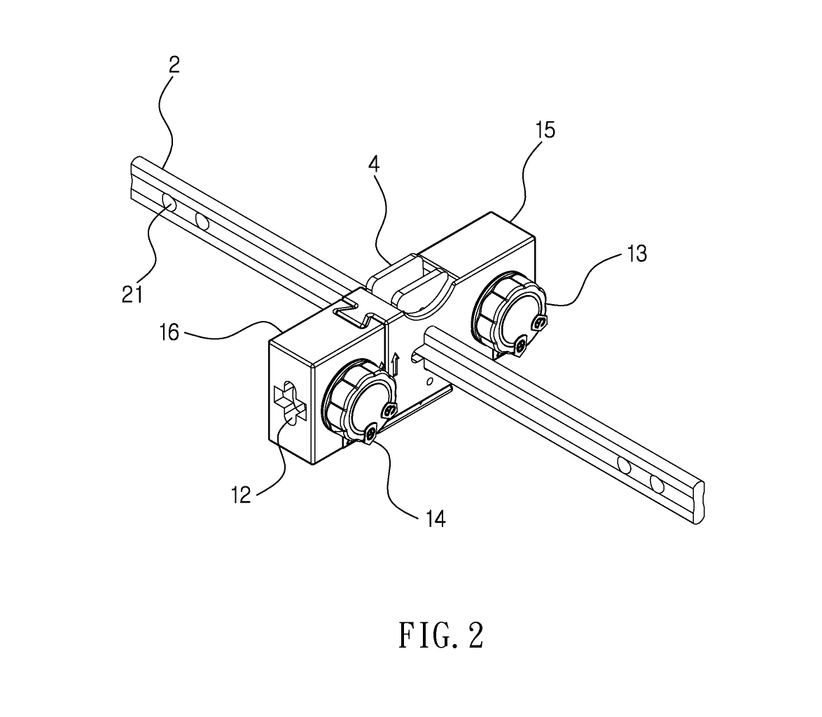

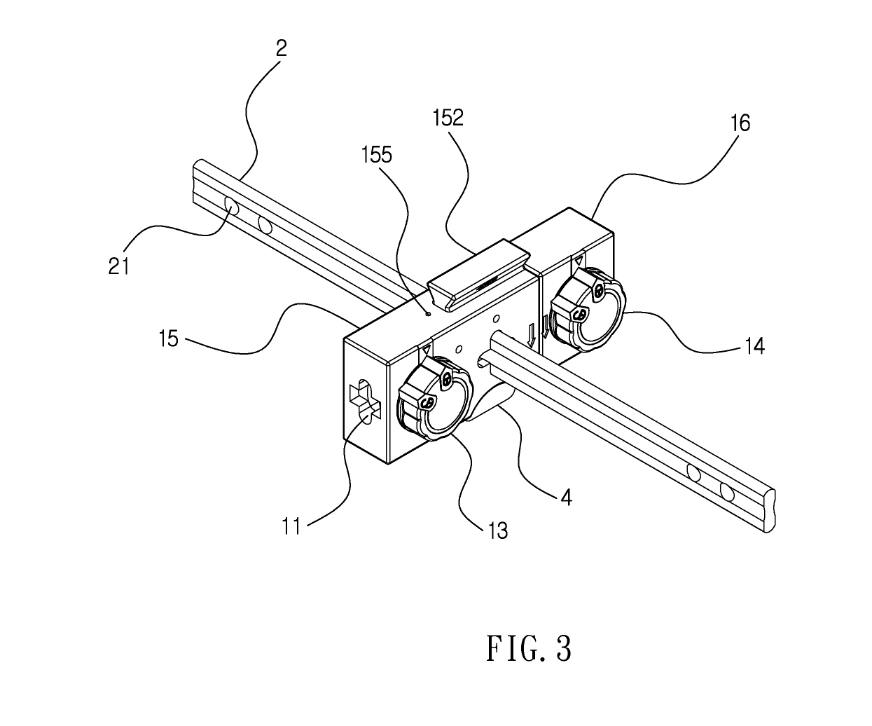

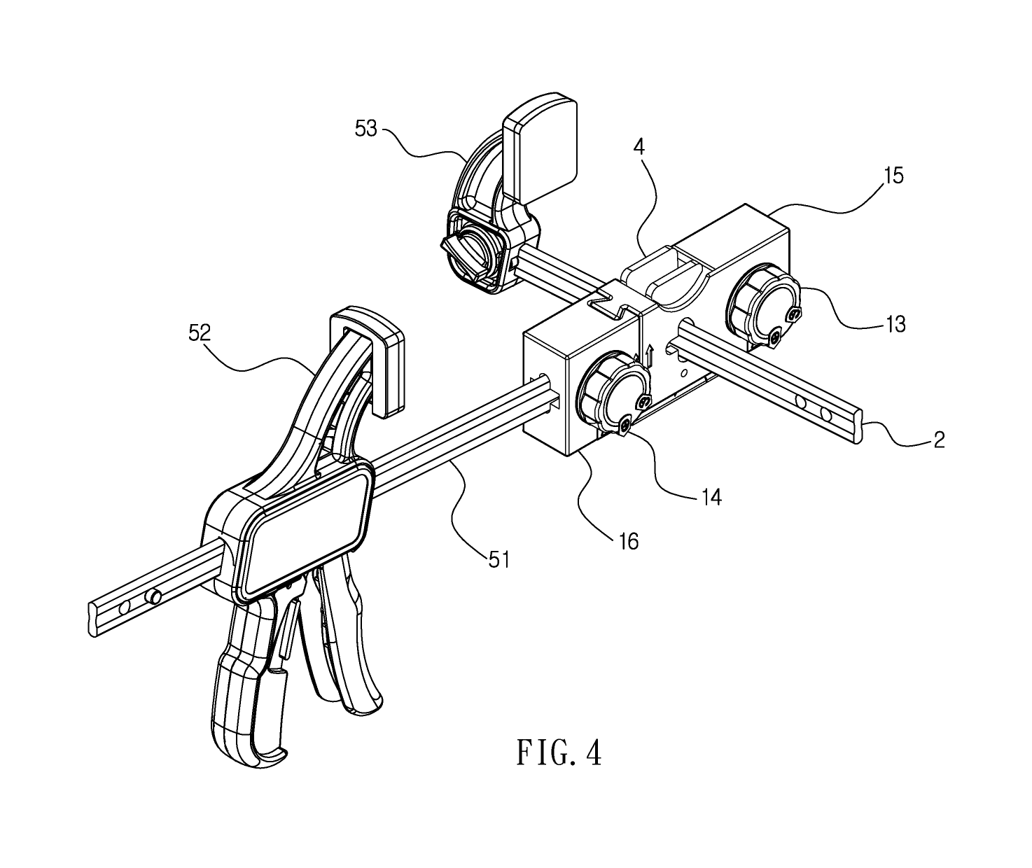

With reference to FIGS. 1 to 4, the connector comprises a body 1, and the body 1 includes a first inserting orifice 11 defined on a first end thereof and includes a second inserting orifice 12 formed on a second end thereof opposite to the first end of the body 1, such that a connection rod 51 for connecting two main woodworking clampers 52 is inserted into the first inserting orifice 11 and the second inserting orifice 12. The body 1 also includes a first fixer 13 inserted into the first inserting orifice 11 from one side surface thereof to fix the connection rod 51 and includes a second fixer 14 inserted into the second inserting orifice 12 from the one side surface of the body 1 to position the connection rod 51 more securely.

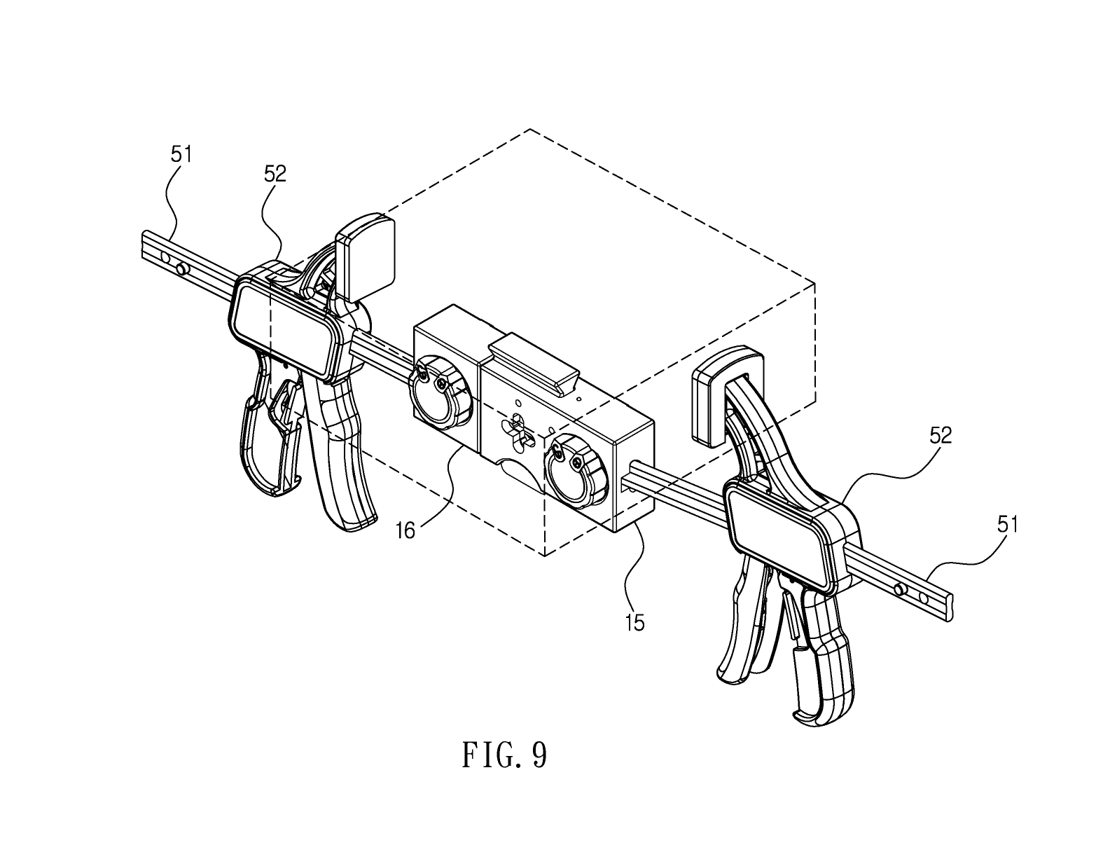

Referring to FIG. 9, the connection rod 51 is inserted into the first inserting orifice 11 and the second inserting orifice 12 to connect the two main woodworking clampers 52 together and to adjust a distance between the two main woodworking clampers 52, thus changing a clamping range. Preferably, an auxiliary woodworking clamper 53 is removed firstly, and then the connection rod 51 is inserted into the first inserting orifice 11 and the second inserting orifice 12, such that the two main woodworking clampers 52 clamp a workpiece therebetween.

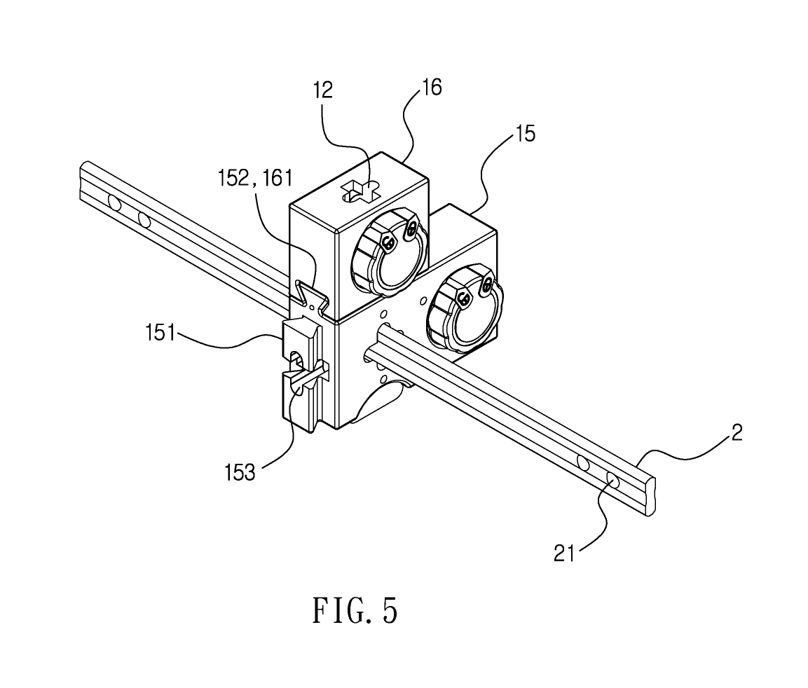

As shown in FIG. 5, the body 1 further includes a first holder 15 and a second holder 16, wherein the first holder 15 has the first inserting orifice 11 and the first fixer 13, and the second holder 16 has the second inserting orifice 12 and the second fixer 14. The first holder 15 has a first dovetail protrusion 151 arranged thereon opposite to the first inserting orifice 11 and has a second dovetail protrusion 152 extending outwardly from a first end surface thereof. The second holder 16 has a first dovetail groove 161 arranged thereon opposite to the second inserting orifice 12 to selectively retain with the first dovetail protrusion 151 or the second dovetail protrusion 152, wherein when the first dovetail groove 161 of the second holder 16 retains with the second dovetail protrusion 152 of the first holder 15, an angle between the first inserting orifice 11 and the second inserting orifice 12 is 90 degrees.

Furthermore, the first dovetail protrusion 151 has a third inserting orifice 153 defined thereon to corresponding to the second inserting orifice 12, such that when the first dovetail groove 161 retains with the first dovetail protrusion 151, and the connection rod 51 is inserted into the second holder 16 and the first holder 15, the connection rod 51 inserts into the second inserting orifice 12 of the second holder 16 and the third inserting orifice 153 of the first holder 15, hence the second holder 16 retains with the first holder 15 more securely by using the first dovetail protrusion 151, the first dovetail groove 161, and the connection rod 51.

The first holder 15 further has an accommodating slot 154 defined in a second end surface thereof opposite to the second dovetail protrusion 152 and has a fixing post 2 inserted through the accommodating slot 154, and the accommodating slot 154 has a spring 3 accommodated therein and fitted onto the fixing post 2. The accommodating slot 154 also has two locating pieces 4 fixed therein, wherein the fixing post 2 inserts through the two locating pieces 4, and the spring 3 is defined between and abuts against the two locating pieces 4, wherein the two locating pieces 4 partially extend out of the accommodating slot 154. In addition, the fixing post 2 has two apertures 21 formed on each of two ends thereof to connect with the auxiliary woodworking clamper 53, such that the fixing post 2 is perpendicular to the first inserting orifice 11 and the second inserting orifice 12, and the two main woodworking clampers 52 or the auxiliary woodworking clamper 53 clamps the workpiece at different angles. Preferably, the two locating pieces 4 are pressed downwardly to release the fixing post 2, hence the fixing post 2 is moved to adjust a position of the second clamper 53 on the fixing post 2.

Preferably, the first holder 15 further has two crisscross holes defined on each of two side surfaces thereof, and each of the locating pieces 4 has a crisscross hole formed thereon, such that the fixing post 2 is vertically or horizontally inserted through the first holder 15, and the two main woodworking clampers 52 or the auxiliary woodworking clamper 53 clamps the workpiece at different angles by ways of the fixing post 2.

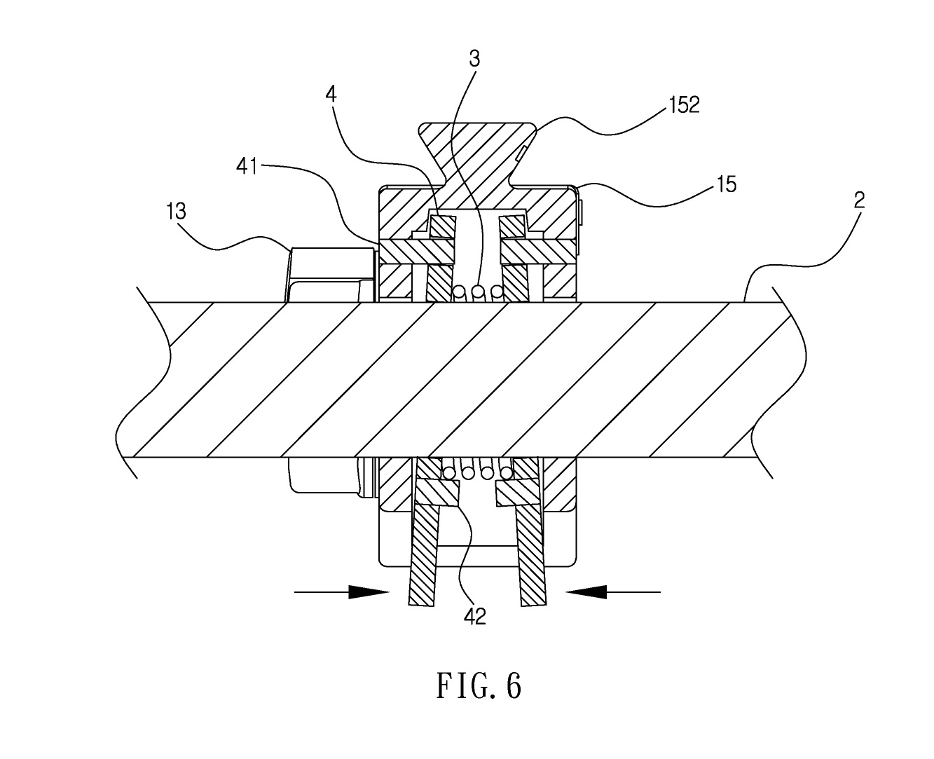

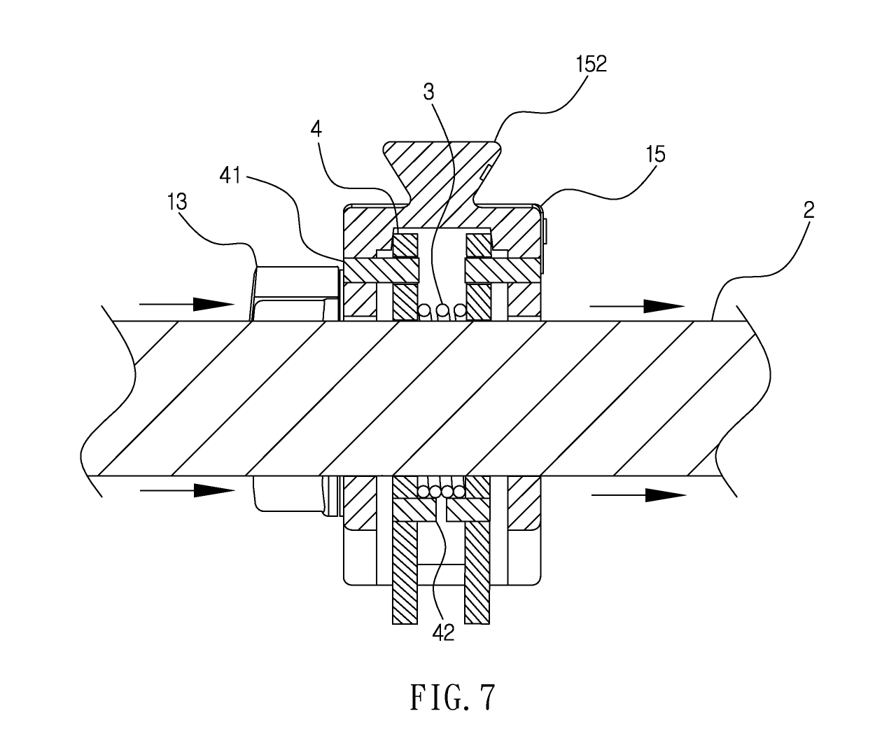

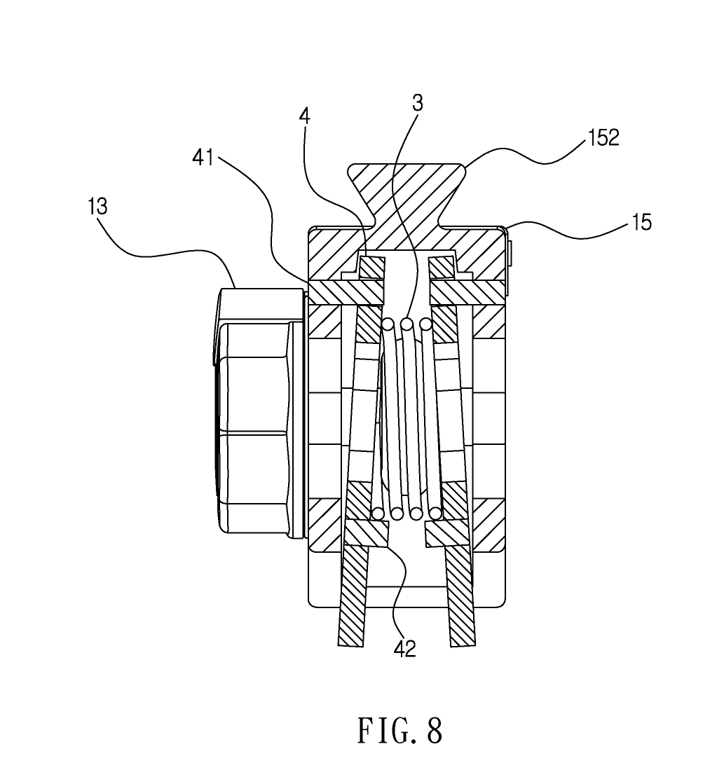

Each of the two locating pieces 4 has a first bolt 41 inserted into the accommodating slot 154 via an upper end thereof and has a second bolt 42 inserted into the accommodating slot 154 via a lower end thereof to locate below the spring 3, such that when the fixing post 2 is removed from the first holder 15, the first bolt 41 and the second bolt 42 position the spring 3 and the each locating piece 4 in the accommodating slot 154 fixedly, as illustrated in FIGS. 6 to 8.

The first holder 15 further has a locking boss 155 arranged on the first end surface thereof adjacent to the second dovetail protrusion 152 to contact with the second holder 16, such that when the second holder 16 retains with the second dovetail protrusion 152, the locking boss 155 contacts with the second holder 16 more securely.

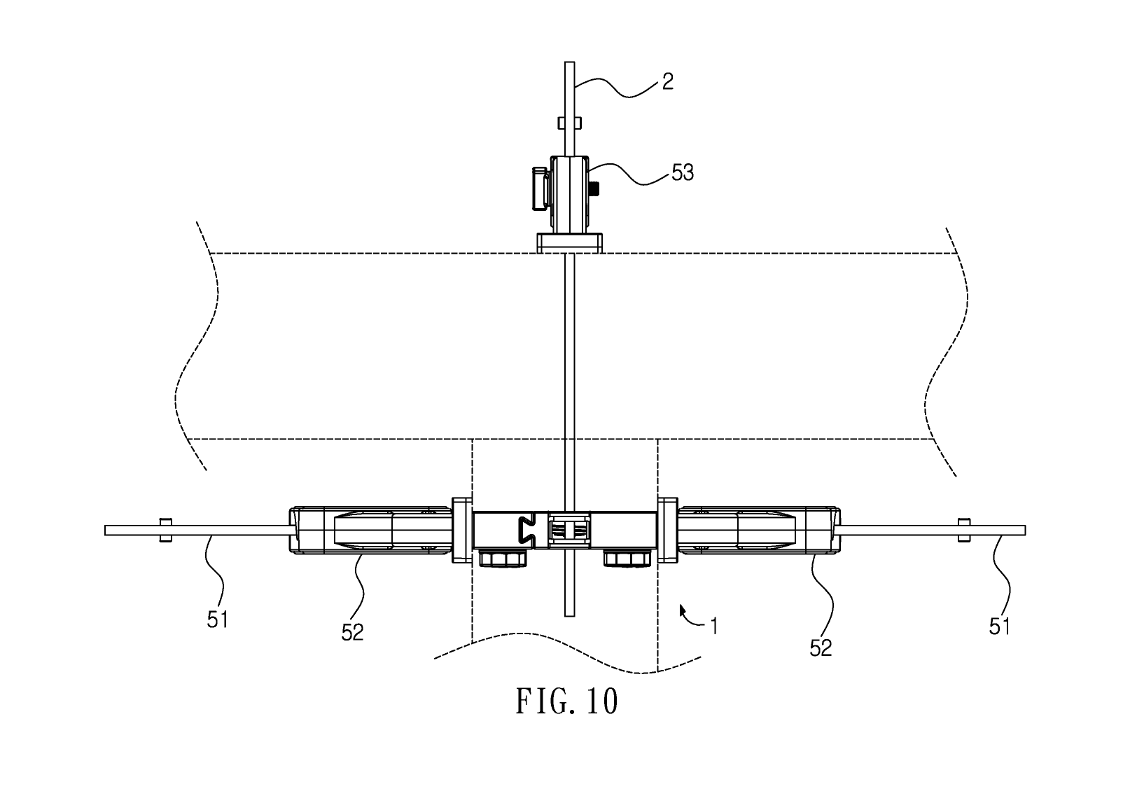

With reference to FIG. 10, a connector according to a second embodiment of the present invention fixes two workpieces (such as two wooden boards) which are connected together in a T configuration, wherein a connection rod 51 is inserted into a first inserting orifice 11 and a second inserting orifice 12, and two main woodworking clampers 52 clamp on two sides of one of the two wooden boards, then a fixing post 2 is inserted through an auxiliary woodworking clamper 53 and a first holder 15 and is released to move the auxiliary woodworking clamper 53, hence the auxiliary woodworking clamper 53 abuts against another of the two wooden boards.

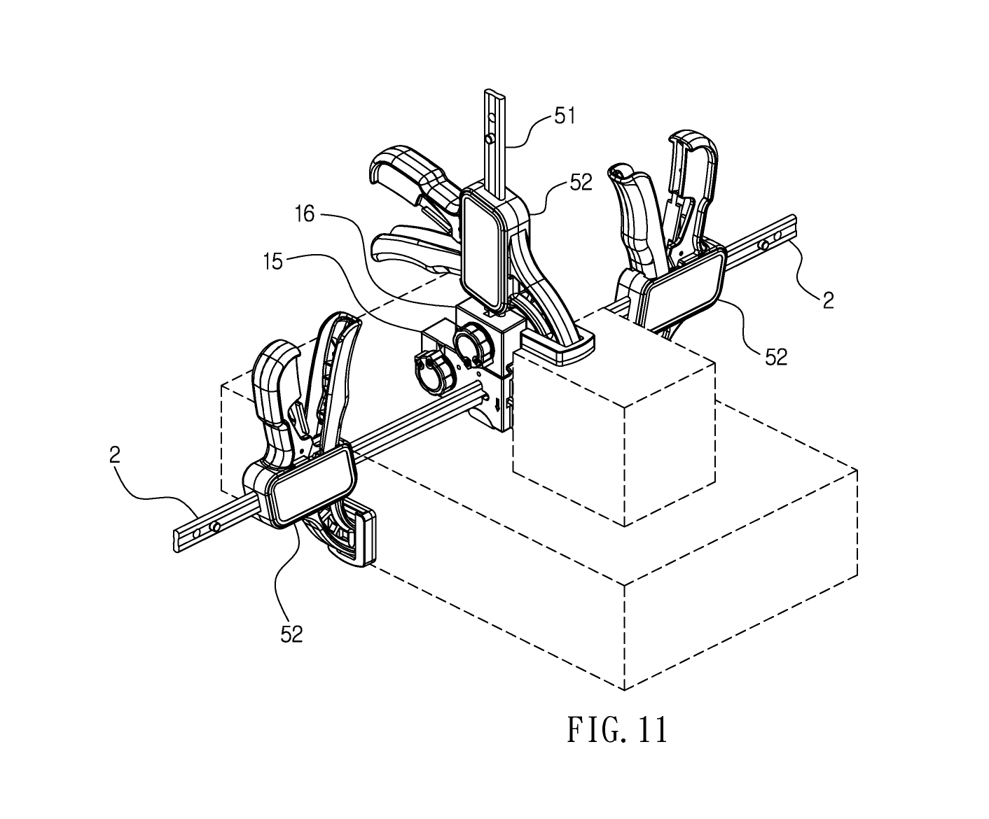

Referring to FIG. 11, a connector according to a third embodiment of the present invention is applied to fix two workpieces together, wherein a fixing post 2 is positioned on one of the two workpieces by matching with two of three main woodworking clampers 52, wherein the two main woodworking clampers 52 clamp on two sides of the one workpiece, and a second holder 16 is fixed perpendicular to a second dovetail protrusion 152 of a first holder 15, thereafter another of the three main woodworking clampers 52 presses another of the two workpieces, thus fixing said another workpiece on the one workpiece.

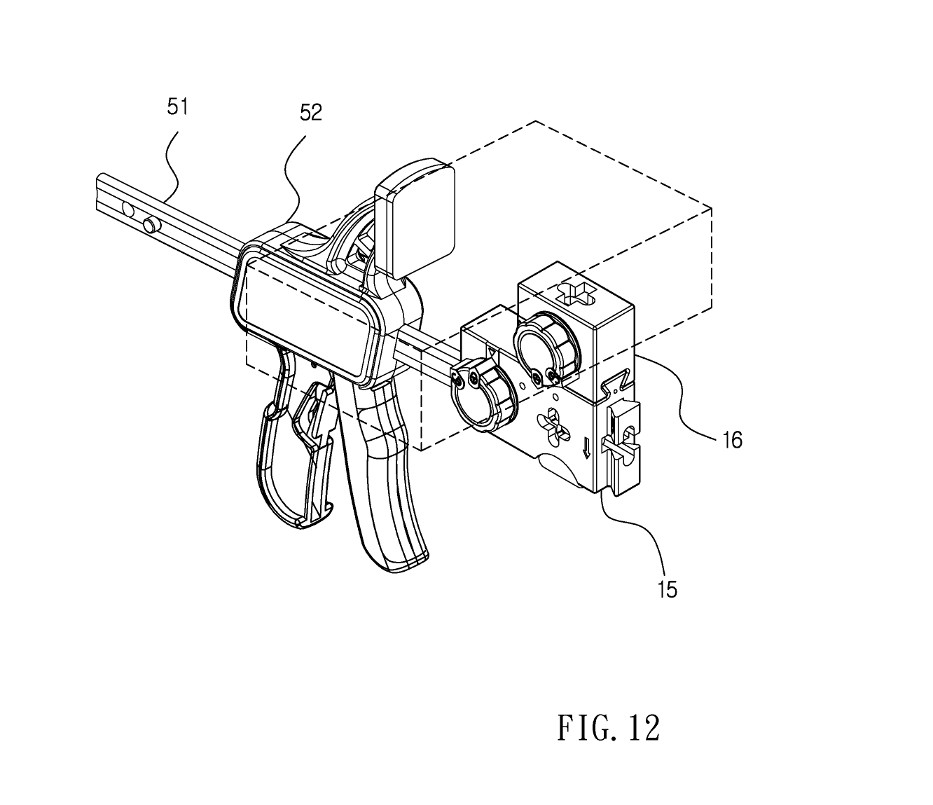

As shown in FIG. 12, a connector according to a fourth embodiment of the present invention is applied to replace an auxiliary woodworking clamper 53, wherein a second holder 16 retains with a second dovetail protrusion 152 of a first holder 15, such that the first holder 15 and the second holder 16 clamp a workpiece by cooperating with a main woodworking clamper 52.

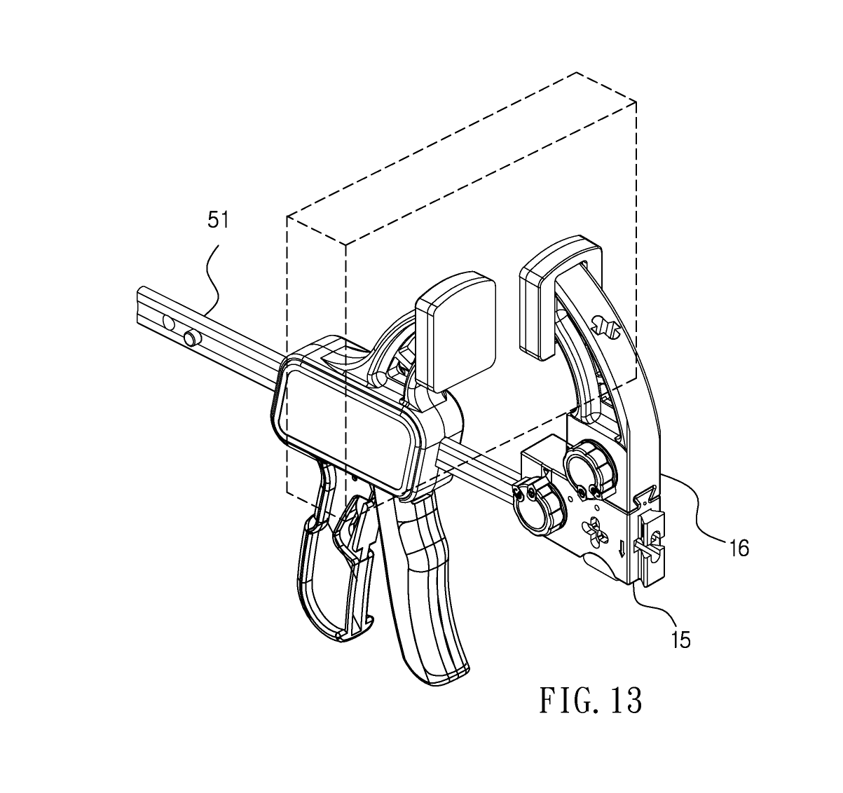

As illustrated in FIG. 13, a connector according to a fifth embodiment of the present invention comprises a second holder 16 used as a clamper.

Accordingly, the connector of the present invention comprises the first inserting orifice 11 and the second inserting orifice 12 in which the connection rod 51 is inserted to connect two clampers together, thus enhancing clamping range. Preferably, the first holder 15 is in connection with the second holder 16 at different angles to change a clamping direction of the plurality of clampers.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A connector comprising a body, and the body including:
a first inserting orifice defined on a first end of the body; a second inserting orifice formed on a second end of the body opposite to the first end of the body, such that a connection rod for connecting two main woodworking clampers is inserted into the first inserting orifice and the second inserting orifice; a first fixer inserted into the first inserting orifice from one side surface of the body to fix the connection rod; and a second fixer inserted into the second inserting orifice from the one side surface of the body to position the connection rod.

2. The connector as claimed in claim 1, wherein the body further includes a first holder and a second holder, wherein the first holder has the first inserting orifice and the first fixer, and the second holder has the second inserting orifice and the second fixer; The first holder also has a first dovetail protrusion arranged thereon opposite to the first inserting orifice and has a second dovetail protrusion extending outwardly from a first end surface thereof; the second holder also has a first dovetail groove arranged thereon opposite to the second inserting orifice to selectively retain with the first dovetail protrusion or the second dovetail protrusion.

3. The connector as claimed in claim 2, wherein the first dovetail protrusion has a third inserting orifice defined thereon to corresponding to the second inserting orifice.

4. The connector as claimed in claim 2, wherein the first holder further has an accommodating slot defined in a second end surface thereof opposite to the second dovetail protrusion and has a fixing post inserted through the accommodating slot, and the accommodating slot has a spring accommodated therein and fitted onto the fixing post; the accommodating slot also has two locating pieces fixed therein, wherein the fixing post inserts through the two locating pieces, and the spring is defined between and abuts against the two locating pieces, wherein the two locating pieces partially extend out of the accommodating slot; the fixing post has two apertures formed on each of two ends thereof to connect with an auxiliary woodworking clamper.

5. The connector as claimed in claim 2, wherein the first holder further has a locking boss arranged on the first end surface thereof adjacent to the second dovetail protrusion to contact with the second holder.

6. The connector as claimed in claim 4, wherein the first holder further has two crisscross holes defined on each of two side surfaces thereof, and each of the locating pieces has a crisscross hole formed thereon, such that the fixing post is vertically or horizontally inserted through the first holder.

7. The connector as claimed in claim 4, wherein each of the two locating pieces has a first bolt inserted into the accommodating slot via an upper end thereof and has a second bolt inserted into the accommodating slot via a lower end thereof to locate below the spring.
